(19) United States
(12) Patent Application Publication
(10) Pub. No.: US 2011/0191587 A1
(43) Pub. Date: Aug. 4, 2011

(54) Media Processing Devices With Joint Encryption-Compression, Joint Decryption-Decompression, And Methods Thereof

(75) Inventors: Jun Tian, Belle Mead, NJ (US); Hong Heather Yu, West Windsor, NJ (US)

(73) Assignee: FutureWei Technologies, Inc., Plano, TX (US)

(21) Appl. No.: 13/015,308

(22) Filed: Jan. 27, 2011

Related U.S. Application Data
(60) Provisional application No. 61/300,704, filed on Feb. 2, 2010.

(51) Int. Cl. H04L 9/32

(52) U.S. Cl. 713/168

(57) ABSTRACT

In one embodiment, a method of adaptive media streaming includes receiving a cipher media stream at a media device. The cipher media stream is compliant with a media compression standard. The cipher media stream is decrypted and decoded using an inverse stream cipher algorithm and a compressed media stream is generated by combining the cipher media stream with a keystream.

This application claims the benefit of U.S. Provisional Application No. 61/300,704, filed on Feb. 2, 2010, entitled “Joint Encryption and Compression,” which application is hereby incorporated herein by reference.

### TECHNICAL FIELD

The present invention relates generally to media processing, and more particularly to media processing devices and methods for joint encryption-compression joint decryption-decompression.

### BACKGROUND

Digital media consumes large amounts of storage and transmission capacity. Consequently, the digital media is compressed and may be down converted to a lower resolution file. Accordingly, digital media is encoded and compressed to minimize the use of resources in transmitting to client devices.

Due to licensing requirements digital media must also be encrypted to avoid third parties from accessing the content. The user requesting the digital media may have only limited rights to the media. Therefore, digital media must also be encrypted before transmission.

Conventionally, encryption and compression processes are performed independently, each requiring significant computational resources. This problem is accentuated during adaptive streaming when a user may request additional media processing. Similarly at the receiving side, the decryption and decompression performed adaptively can consume significant resources. These problems can result in temporary pausing or disruption of the media stream impeding the user's experience of the media.

### SUMMARY OF THE INVENTION

These and other problems are generally solved or circumvented, and technical advantages are generally achieved, by illustrative embodiments of the present invention.

In accordance with an embodiment of the present invention, a method of streaming media from a network component comprises generating a decorrelated media stream by applying a decorrelation transform to media content to be streamed. The method further comprises quantizing the decorrelated media stream and encoding the quantized decorrelated media stream. In one embodiment, the encoding comprises generating an encoded media stream by applying entropy encoding on the quantized decorrelated media stream, and generating a cipher media stream comprising the media content by combining the encoded media stream with a keystream. The cipher media stream is generated using a stream cipher algorithm. At least one of the generating a decorrelated media stream, the quantizing the decorrelated media stream, and the encoding the quantized decorrelated media stream is performed using a processor.

In accordance with another embodiment of the present invention, a method of adaptive media streaming comprises receiving a cipher media stream at a media device. The cipher media stream is compliant with a media compression standard. The method further comprises decrypting and decoding the cipher media stream. In one embodiment, the decoding comprises using an inverse stream cipher algorithm to generate a compressed media stream by combining the cipher media stream with a keystream.

In accordance with another embodiment of the present invention, a media server comprises a decorrelator configured to generate a decorrelated media stream by applying a decorrelation transform to media content to be streamed. The media server further includes a quantizer and an encoder. The quantizer is configured to quantize the decorrelated media stream. The encoder comprises an entropy encoder, a stream cipher generator, and a keystream generator. The entropy encoder is adapted to generate an encoded media stream by applying entropy encoding on the quantized decorrelated media stream. The stream cipher generator is adapted to use a stream cipher algorithm to generate a cipher media stream by combining the encoded media stream with a keystream from the keystream generator.

In accordance with another embodiment of the present invention, a media device comprises a receiver configured to receive a cipher media stream. The cipher media stream is compliant with media compression standards. The media device further comprises a decoder configured to decrypt and decode the cipher media stream. The decoder comprises a stream cipher generator and a keystream generator. The stream cipher generator is configured to generate a compressed media stream by combining the cipher media stream with a keystream from the keystream generator using an inverse stream cipher algorithm.

The foregoing has outlined rather broadly the features of an embodiment of the present invention in order that the detailed description of the invention that follows may be better understood. Additional features and advantages of embodiments of the invention will be described hereinafter, which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1, which includes FIGS. 1A and 1B, illustrates a prior art approach to media communication;

FIG. 2 illustrates a joint encryption and compression process and a joint decryption and decompression process in accordance with an embodiment of the invention;

FIG. 3 illustrates operations at a media server in accordance with an embodiment of the invention;

FIG. 4 illustrates the components within a media server implementing embodiments of the invention;

FIG. 5 illustrates operations at a media server under adaptive streaming in accordance with embodiments of the invention;

FIG. 6 illustrates a representative media server in accordance with embodiments of the invention;

FIG. 7 illustrates operations at a media device in accordance with an embodiment of the invention;

FIG. 8 illustrates the components within a media device implementing embodiments of the invention;

FIG. 9 illustrates operations at a media device undergoing adaptive streaming in accordance with embodiments of the invention; and

FIG. 10 illustrates a representative media device in accordance with embodiments of the invention.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF ILLUSTRATIVE EMBODIMENTS

The making and using of various embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

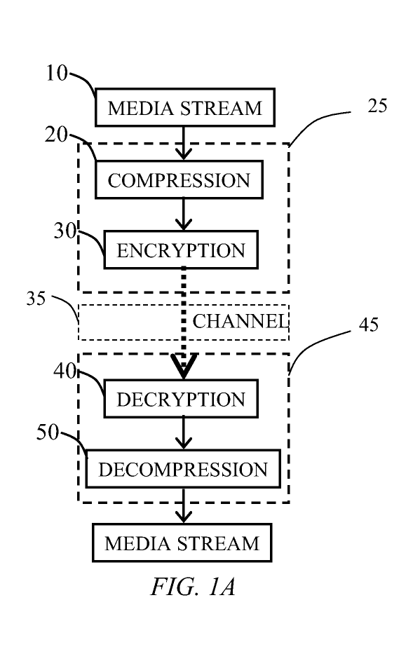

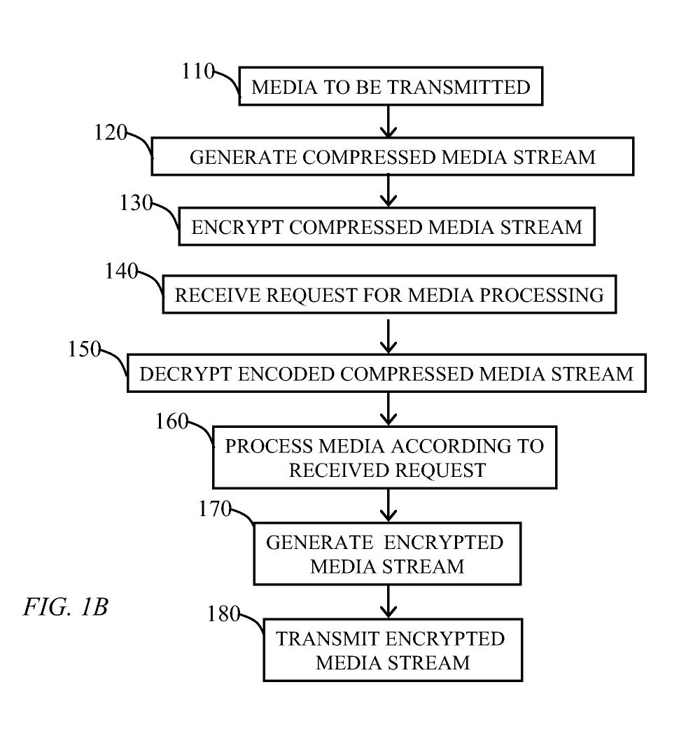

FIG. 1, which includes FIGS. 1A and 1B, illustrates a prior art approach to media communication during adaptive streaming.

FIG. 1A illustrates a media server 25 transporting a media stream to a media device 45 (client device). The media server 25 may be a network server, a local computer, or any suitable device that is connected to the media device 45 through a wireless or wired connection. The media server 25 may be a server located in the internet.

Because of the large band width required for communication, the media stream 10 is compressed (step 20). Further, in adaptive streaming, the media server 25 selects a compression based on the network connection and attributes of the device requesting the media. Next, encryption may be performed (step 30) to prevent third parties from accessing the transmitted media stream. The encrypted and compressed media stream is transmitted through a channel 35, which may include both wired and wireless connections, to the media device 45. At the media device 45, the encrypted media stream is decrypted (step 40) and decompressed (step 50) to recover the media stream.

The communication approach described above suffers from efficiency problems during adaptive streaming when a user requests further media operations. For example, if the media device 45 requests the media server 25 to transmit the media stream after a fast-forward or rewind operation, the media server 25 may be required to perform significant processing as described in FIG. 1B.

FIG. 1B illustrates operations at a transmitter or serving gateway under a prior art media processing scheme in which a user at a media device requests further media processing.

When a media device serving a user requests media from the media server, the requested media is processed (step 110) depending on the network connection and/or configuration of the media device. The media to be transmitted is recovered, for example, from another networked computer directly or indirectly coupled with the media server. The media may also be stored in a storage medium from which it is recovered, for example, at the beginning of the session with the media device.

The processing of the media includes compression to minimize band width (step 120) and encryption to avoid unlicensed users from accessing the content (step 130). The compressing media may be transmitted to the requesting media device. However, these processes may be interrupted when a user requests the media server to perform media processing. For example, the user may request to fast forward, rewind, change frame rate etc during the transmission.

Upon receipt of a user request (step 140), the media server decrypts the media stream (step 150) that was being transmitted so that it can perform the media processing. The decryption is required because conventional encryption while providing strong protection is not dependent on the data type. Therefore, irrespective of the data format being encrypted the encrypted media is not compatible with any media format i.e. not compliant with any media compression standards. Therefore, media operations can not be performed on the encrypted media.

After decryption, the unencrypted media stream is processed according to the received request (step 160). Before commencing transmission again, the unencrypted media has to be encrypted again (step 170). This encrypted media stream (step 180) is transmitted to the media device. This pipelined process is very inefficient as it requires an additional encryption and decryption process (steps 150 and 170).

While not illustrated separately, the same problem may be present on the media device side. For example, the media device receiving the media stream may save the media into a local memory. Because of licensing requirements, the media device may be allowed to store the files only in the encrypted format. If the user requests media processing, the media device has to decrypt and encrypt all of the stored media stream. For example, if the user fast forwards to the last few frames of a large movie, the media device has to unencrypt the whole media stream to locate the final few frames. Then the media device has to encrypt this large file so as to store the file. This can be very computationally expensive especially on media devices that typically do not have significant computational power and/or memory. Embodiments of the invention overcome these and other problems by incorporating a joint encryption and compression process as described further below.

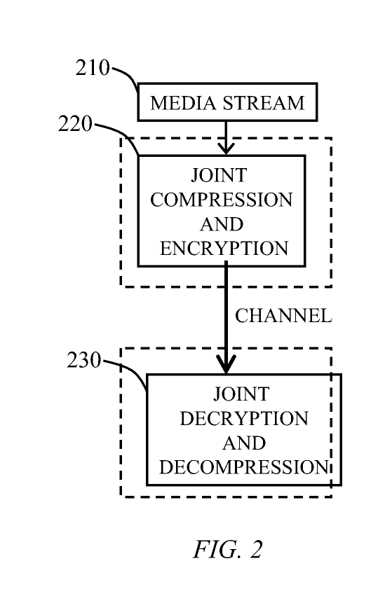

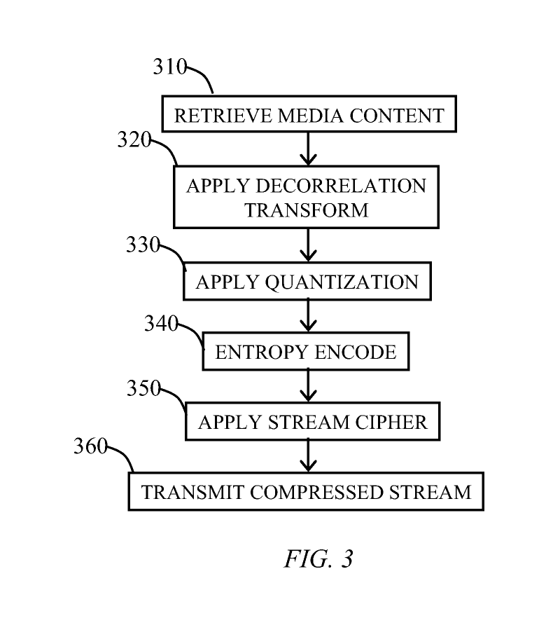

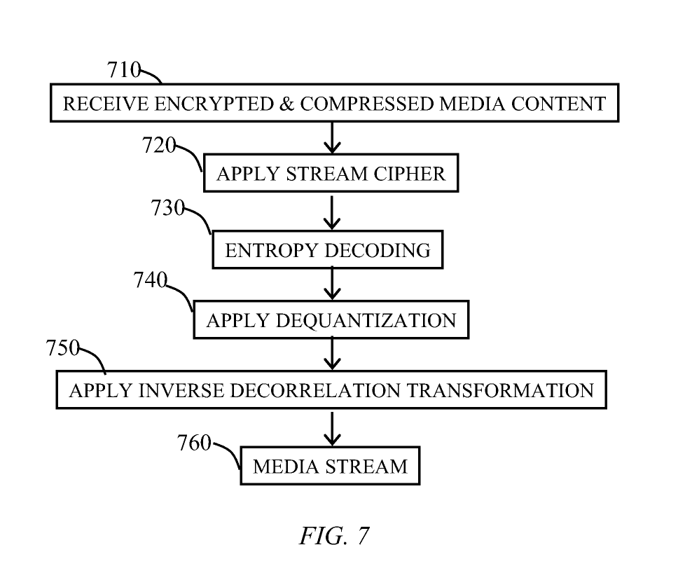

The framework of a joint encryption and compression process used at a media server and a joint decryption and decompression process at a media device will be described using FIG. 2. Embodiments of the invention relating to a transmitting media server will be described using FIGS. 3-6. Embodiments of the invention relating to a receiving media device (client device) will be described using FIGS. 7-10.

FIG. 2 illustrates a joint encryption and compression process and a joint decryption and decompression process in accordance with an embodiment of the invention.

The embodiments of the invention described herein use transcoding or transform coding. In transcoding, the compression is based on the media device being served. This allows the media server to efficiently lower the band width based on the capabilities of the media device. For example, a lossy compression may be used wherein only a lower quality of the original media stream can be recovered at the media device. This may be advantageous when the media device does not have the capability to use the additional information in the original media stream. Further, in many cases, the media device may be incapable of processing higher resolution files. Therefore, sending the additional information in the original media stream may take up valuable band width without being utilized at the user end.

Consequently, in transform coding, knowledge of the application is used to choose information to discard, thereby lowering its bandwidth. The remaining information can then be compressed via a variety of methods. When the output is decoded, the resulting output may not be identical to the original input, but close enough for the purpose of the application.

In various embodiments, the media stream 210 is simultaneously compressed and encrypted to form an encrypted and compressed media stream. This encrypted and compressed media stream is transmitted wirelessly and/or through wired communication to a media device 230, where it is decrypted and decompressed. Advantageously, the joint processing leverages the efficiency of compression algorithms that have been optimized for compressing media. The encryption is achieved by a low complexity stream cipher applied to the compressed media, which does not significantly alter the computational requirements. Excellent security can be achieved despite the use of a low level stream cipher. This is possible because of the similarity between compression and encryption. In general, both compression and encryption processes remove redundancy. In particular, compressed media stream has very little redundancy as compared to regular media that is encrypted. Embodiments of the invention exploit this similarity between encryption and compression.

In encryption, a media file, e.g., a plain text having a certain structure and semantics is transformed to a ciphertext that is statistically random with no apparent structure. During encryption, the structure of the input file is completely scrambled without redundancy so that the output appears to be random data. Therefore, encryption hides the redundancy to produce a random output that is almost free of redundancy.

A compression process is conceptually similar to encryption. During compression, raw multimedia files that may have a lot of redundancy are converted to an output having almost no redundancy. A key difference between encryption and compression is that operations in encryption are controlled by a secret key so that it is impossible to decrypt without knowing the key. In contrast, in compression, all operations are performed according to agreed standards, which allow the raw content to be decoded from the compressed media stream.

Embodiments of the invention leverage the compression algorithms that already have performed the heavy computational work to remove redundancy from the input data.

Further, advantageously, the media format of the compressed media stream is retained allowing media processing of the encrypted media stream.

FIG. 3 illustrates operations at a media server in accordance with an embodiment of the invention.

Referring to FIG. 3, media content is retrieved (step 310). The media content may be stored locally or over a network. The media content may be retrieved when a user initiates a session and requests streaming of the media.

Next, the retrieved media is compressed. The compression comprises applying a decorrelation transform (step 320), applying a quantization (step 330), and entropy encoding (step 340).

During the decorrelation transform stage, autocorrelation within the media stream is reduced without changing other aspects of the media stream. The decorrelation transform may include linear and/or non-linear decorrelation algorithms. Examples of algorithms may include discrete cosine transform, discrete wavelet transform, or other algorithms that are optimized based on the media format.

A quantization algorithm is applied to the output of the decorrelation transform (step 330). During quantization, the output from the decorrelation transform is approximated, for example, a lossy compression algorithm. As an example, the number of discrete symbols in a given media stream may be reduced. For example, the number of colors required to represent a digital image may be reduced.

Next entropy encoding is applied (step 340) to the quantized media stream. During this stage, unique prefix codes are generated and assigned to each unique symbol in the quantized media stream. Compression is achieved by replacing each fixed-length input symbol by the corresponding variable-length prefix codeword. The length of each codeword is approximately proportional to the negative logarithm of the probability. Using the shortest codes for the most common symbols achieves the maximum compression. The entropy encoding algorithm may use Huffman encoding, arithmetic encoding, or other encoding algorithms, for example, depending on the type of the media.

Next a stream cipher generator is applied to the output of the entropy encoder (step 350). The stream cipher generator is coupled to the output of a keystream generator, which generates a keystream kᵢ, e.g., a stream of 1s and 0s. The keystream is a stream of random or pseudorandom characters.

In various embodiments, the keystream from the keystream generator is combined with the compressed media to produce an encrypted and compressed media. In various embodiments, the stream cipher generator encrypts data one bit, or one byte, or one word, or other fix-length data type, at a time. In various embodiments, the encrypted/compressed media stream is produced by combining the compressed media stream and the keystream using a logical operator. In one embodiment, an exclusive or (XOR) operation is applied on the compressed media stream pᵢ and the keystream kᵢ to obtain a cipher media stream cᵢ as cᵢ=pᵢ⊕kᵢ. Therefore, if exactly one of the compressed media stream p, and the keystream kᵢ bits is a 1, then the exclusive or returns a 1 as the cipher media stream cᵢ. If both compressed media stream pᵢ and the keystream kᵢ bits are 1s or both compressed media pᵢ and the keystream kᵢ bits are 0s, then the exclusive or returns a 0 as the cipher media stream cᵢ.

Using the cipher stream generator, the joint encryption and compression system provides complete protection to the media content, while keeping the media codec syntax (and also file syntax) compliant with the standard media codec (and file format).

The compressed and encrypted media stream can be transmitted to a media device (step 360).

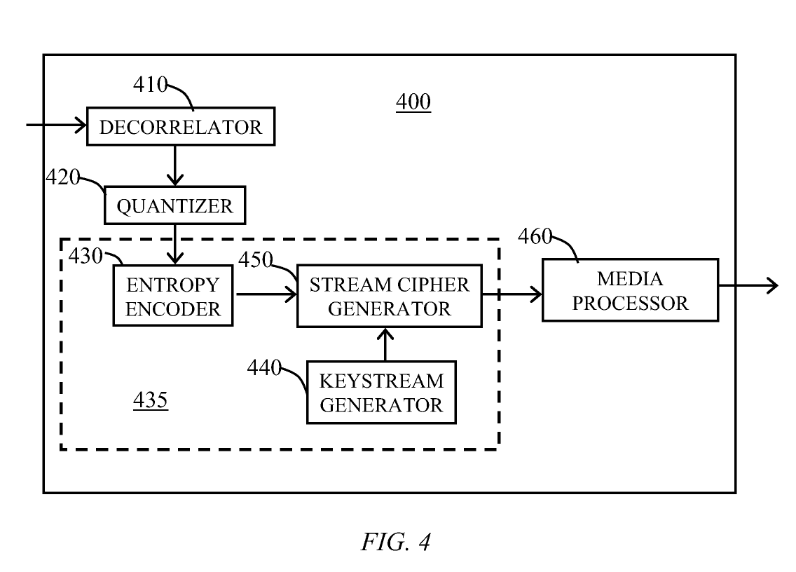

FIG. 4 illustrates the components within the media server implementing embodiments of the invention.

The media server 400 comprises a decorrelator 410 for applying the decorrelation transform. The output of the decorrelator 410 is coupled to a quantizer 420, which performs the quantization of the decorrelated media. The output of the quantizer 420 is input to an encoder 435, which generates the encrypted and compressed media stream cᵢ.

The encoder 435 comprises an entropy encoder 430, a keystream generator 440, and a stream cipher generator 450. The entropy encoder 430 receives the quantized media stream from the quantizer 420 and generates the compressed media stream pᵢ. The output of the entropy encoder 430 is input to the stream cipher generator 450. The stream cipher generator 450 combines the compressed media stream pᵢ with the keystream kᵢ from the keystream generator 440 to generate the encrypted and compressed media stream cᵢ.

The output from the encoder 435 may be an input to a media processor 460 for media processing.

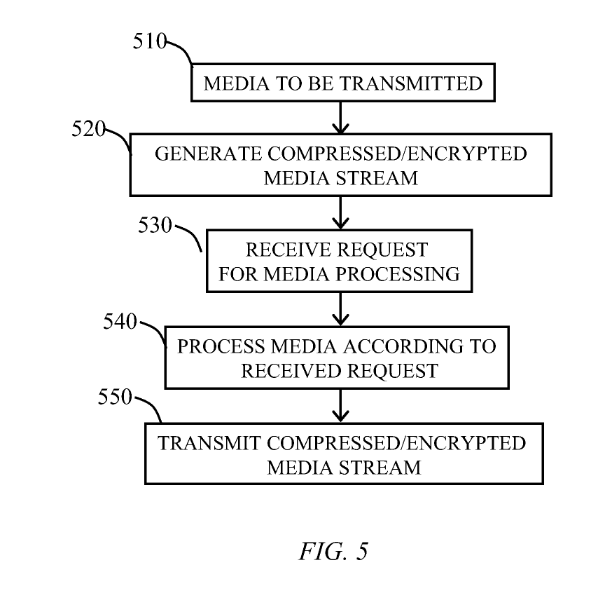

FIG. 5 illustrates operations at a media server undergoing adaptive streaming in accordance with embodiments of the invention.

As illustrated in FIG. 5, media to be transmitted is retrieved, and an encrypted-compressed media stream is generated as described above in various embodiments (steps 510 and 520). The media server may begin transmission of the encrypted and compressed media to the media device making the request (e.g., step 550).

During the on-going session, the media device may request a media operation (step 530). When the media server receives a request for media processing, the media server performs the media operation directly on the encrypted and compressed data without a separate decryption step (step 540). Direct media processing on the encrypted media stream is possible because the encrypted media stream is compliant with compressed media codec standards, such as MPEG-2, H.264 etc. This allows the media server to efficiently perform the operation without incurring significant additional computational overhead due to the media operation. The media server continues transmitting the media stream after the media processing (step 550).

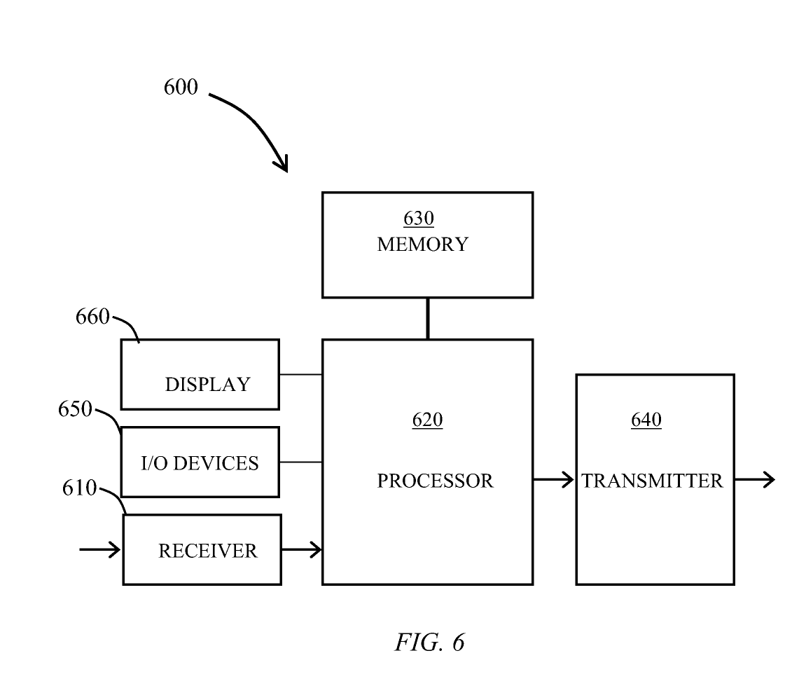

FIG. 6 illustrates a representative media server in accordance with embodiments of the invention.

The media server 600 includes a receiver 610, which may include a wireless antenna receiver and/or a wired network connection port for receiving the media content, for example, if it is stored at a remote location. The media server 600 also includes a memory 630, which may include both a non-volatile memory and a volatile memory. In one embodiment, instructions for performing the operations as described in FIG. 3 and/or FIG. 5 may be stored in a non-transitory storage medium such as a magnetic storage medium or a solid state storage medium in the memory 630.

The media server 600 may include further I/O devices 650 for inputting and outputting data. For example, the I/O devices 650 may include an optical disc such as a laser readable medium, for example, a compact disc reader, a blue ray disk reader, and/or digital video reader etc. In one or more embodiments, the instructions for performing the operations as described in FIG. 3 and/or FIG. 5 may be stored in an optical disc, which is a non-transitory storage medium.

The media server 600 may also include a display 660 and a transmitter 640 for transmitting the compressed data. The transmitter 640 may include plurality of wireless antennas and/or a wired port. The transmitter 640 and the receiver 610 can be combined together in some embodiments.

The media server 600 includes a processor 620 configured to execute the instructions for performing the operations as described in FIG. 3 and/or FIG. 5. The processor 620 may comprise a single processor or a plurality of processors.

In one embodiment, the processor 620 comprises the decorrelator 410, the quantizer 420, the entropy encoder 430, the keystream generator 440, the stream cipher generator 450, and the media processor 460 as described with respect to FIG. 4. In another embodiment, the processor 620 comprises a plurality of separate chips performing one or more of the functions of the decorrelator 410, the quantizer 420, the entropy encoder 430, the keystream generator 440, the stream cipher generator 450, and the media processor 460.

In an alternative embodiment, the functions of the decorrelator 410, the quantizer 420, the entropy encoder 430, the keystream generator 440, the stream cipher generator 450, and the media processor 460 may be performed within the same processor at different times. In other words, the processor 620 behaves as the decorrelator 410, the quantizer 420, the entropy encoder 430, the keystream generator 440, the stream cipher generator 450, and the media processor 460 at various stages of the media processing.

FIG. 7 illustrates operations at a media device in accordance with an embodiment of the invention.

The media device receives the compressed and encrypted media stream from a media server (step 710). The media stream may have been transmitted through wired communication channels and/or a wireless communication channel.

The media device applies a stream cipher algorithm to decrypt the encrypted media stream and recovers the compressed media stream. A stream cipher generator applies a symmetric algorithm to the cipher media stream from the media server. This allows performing the reverse of the stream cipher algorithm performed at the media server.

The media device may also receive a key from the serving media server through a secure channel for generating a keystream kᵢ at a keystream generator in the media device. In various embodiments, the compressed media stream pᵢ is produced by combining the encrypted-compressed media stream cᵢ and the keystream kᵢ using a logical operator. In one embodiment, an exclusive or (XOR) operation is applied on the encrypted and compressed media stream cᵢ and the keystream kᵢ to obtain the unencrypted compressed media stream pᵢ as pᵢ=cᵢ⊕kᵢ.

After generating the compressed media stream, entropy decoding, dequantization, and inverse decorrelation transform are applied to obtain the uncompressed media stream (step 730, step 740, and step 750). For example, entropy decoding may be similar to entropy encoding. During entropy decoding, the input compressed media stream may be converted into the intermediate symbols, which may be subsequently converted into quantized coefficients. The dequantization step produces an input suitable for applying the inverse decorrelation transform. An inverse decorrelation transform is next applied. For example, if the original compression applied a discrete cosine transform, an inverse discrete cosine transform may now be applied.

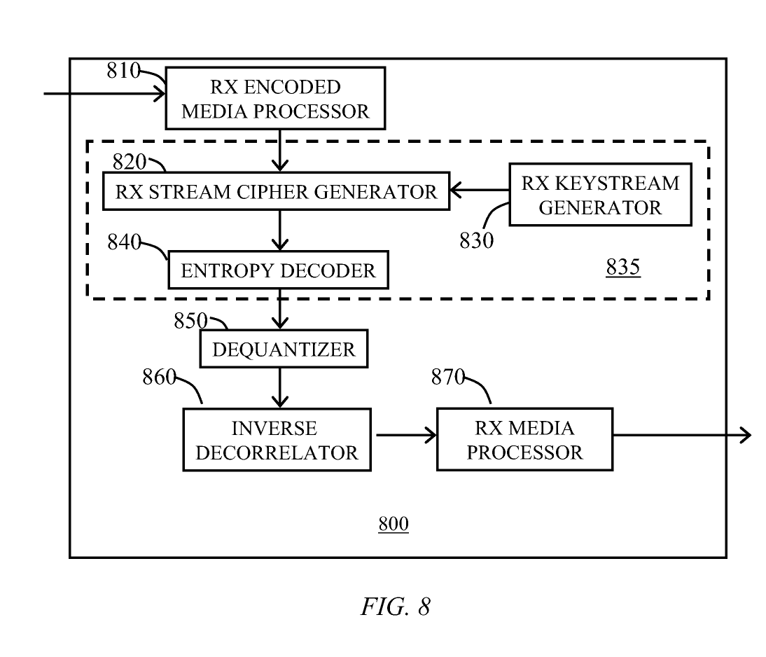

FIG. 8 illustrates the components within the media device implementing embodiments of the invention.

The media device may be a networked computer, standalone computer, laptop, netbooks, hand held device including cell phones, smart phone, and other user devices used in media processing. The media device 800 comprises an optional Rx encoded media processor 810 which is configured to execute instructions to perform media processing on compressed media stream. Advantageously, because the encrypted media stream received at the media device 800 is compliant with media format, the Rx encoded media processor 810 can directly manipulate the encrypted media stream without any further decryption.

The encrypted and compressed media stream is input into a decoder 835, which includes a Rx stream cipher generator 820, a Rx keystream generator 830, and an entropy decoder 840. The Rx stream cipher generator 820 combines the encrypted media stream cᵢ with a keystream kᵢ from the keystream generator 830 to generate the compressed media stream pᵢ.

The entropy decoder 840 applies entropy decoding to the compressed media stream pᵢ. The output of the entropy decoder 840 is input to a dequantizer 850, which generates an output for applying the inverse decorrelation transform at the inverse decorrelator 860. The media stream obtained after the inverse decorrelator 860 may not be an original copy if lossy compression algorithms are used. The media stream from the inverse decorrelator 860 may be further processed, for example, in a Rx media processor 870 for media processing operations, which may include displaying the output.

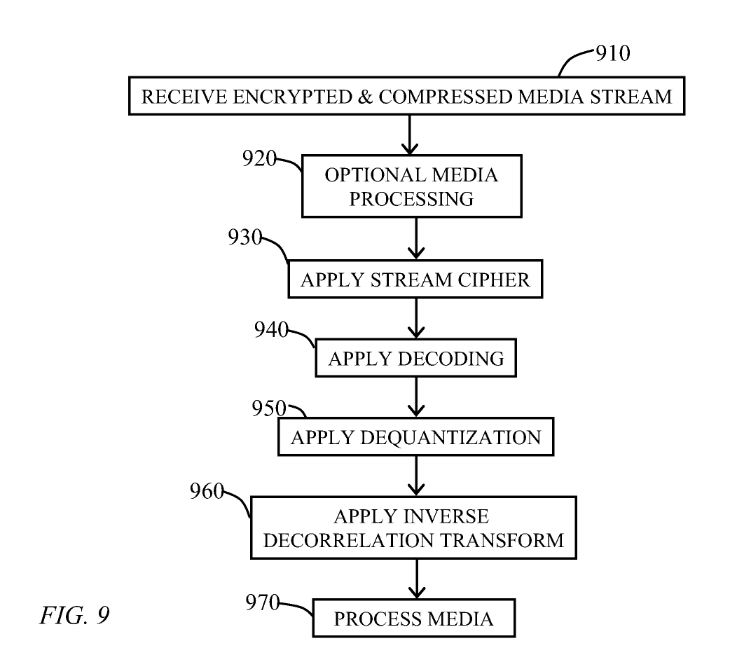

FIG. 9 illustrates operations at a media device undergoing adaptive streaming in accordance with embodiments of the invention.

Similar to FIG. 7, the operations illustrates receiving an encrypted media stream and applying an inverse stream cipher, decoding, dequantization, and inverse decorrelation transform (step 930, step 940, step 950, and step 960). However, unlike FIG. 7, FIG. 9 includes the additional step of performing optional media processing (step 920). In various embodiments, the media processing may be performed directly on the encrypted media stream because the encrypted media stream is compliant with compressed media codec standards, such as MPEG-2, H.264 etc.

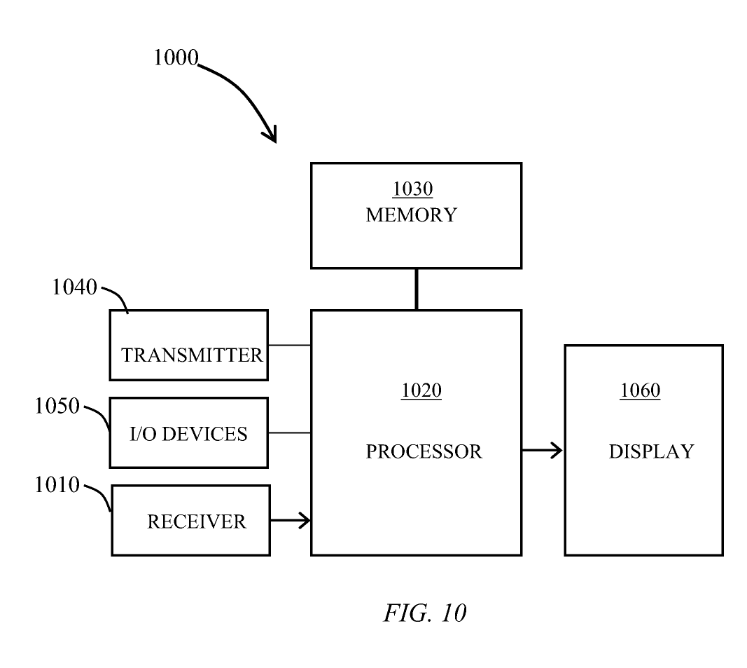

FIG. 10 illustrates a representative media device in accordance with embodiments of the invention.

The media device 1000 includes a receiver 1010, which may include a wireless antenna receiver and/or a wired network connection port for receiving the encrypted media stream. The media device 1000 also includes a memory 1030, which may include both a non-volatile memory and a volatile memory. In one embodiment, instructions for performing the operations as described in FIG. 7 and/or FIG. 9 may be stored in a non-transitory storage medium such as a magnetic storage medium or a solid state storage medium in the memory 1030.

The media device 1000 may include further I/O devices 1050 for inputting and outputting data. For example, the I/O devices 1050 may include an optical disc such as a laser readable medium, for example, a compact disc reader, a blue ray disk reader, and/or digital video reader etc. In one or more embodiments, the instructions for performing the operations as described in FIG. 7 and/or FIG. 9 may be stored in an optical disc, which is a non-transitory storage medium.

The media device 1000 may also include a display 1060 for displaying the media stream after decryption and decompression. The media device may also comprise a transmitter 1040 for communicating with the media server. The transmitter 1040 may include a wireless antenna and/or a wired port.

The media device 1000 includes a processor 1020 configured to execute the instructions for performing the operations as described in FIG. 7 and/or FIG. 9. The processor 1020 may comprise a single processor or a plurality of processors.

In one embodiment, the processor 1020 comprises the Rx encoded media processor 810, the Rx stream cipher generator 820, the Rx keystream generator 830, the entropy decoder 840, the dequantizer 850, the inverse decorrelator 860, and the Rx media processor 870 as described with respect to FIG. 8. In another embodiment, the processor 1020 comprises a plurality of separate chips performing one or more of the functions of the Rx encoded media processor 810, the Rx stream cipher generator 820, the Rx keystream generator 830, the entropy decoder 840, the dequantizer 850, the inverse decorrelator 860, and the Rx media processor 870.

In an alternative embodiment, the functions of the Rx encoded media processor 810, the Rx stream cipher generator 820, the Rx keystream generator 830, the entropy decoder 840, the dequantizer 850, the inverse decorrelator 860, and the Rx media processor 870 may be performed within the same processor at different times. In other words, the processor 1020 behaves as the Rx encoded media processor 810, the Rx stream cipher generator 820, the Rx keystream generator 830, the entropy decoder 840, the dequantizer 850, the inverse decorrelator 860, and the Rx media processor 870 at various stages of the media processing.

The above described embodiments of a media server (e.g., FIG. 4) and the media device (e.g., FIG. 6) (as well as the methods described above with respect to FIGS. 3A, 5, 7, and 9) may also be illustrated in terms of methods comprising functional steps and/or non-functional acts. Usually, functional steps describe the invention in terms of results that are accomplished, whereas non-functional acts describe more specific actions for achieving a particular result. Although the functional steps and/or non-functional acts may be described or claimed in a particular order, the present invention is not necessarily limited to any particular ordering or combination of steps and/or acts. Further, the use (or non use) of steps and/or acts in the recitation of the claims—and in the description of the operational diagrams(s), for example, FIGS. 3A, 5, 7, and 9—is used to indicate the desired specific use (or non-use) of such terms.

Although the present invention and its advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method of streaming media from a network component, the method comprising:
generating a decorrelated media stream by applying a decorrelation transform to media content to be streamed;
quantizing the decorrelated media stream; and
encoding the quantized decorrelated media stream, wherein the encoding comprises:
generating an encoded media stream by applying entropy encoding on the quantized decorrelated media stream, and generating a cipher media stream comprising the media content by combining the encoded media stream with a keystream, the cipher media stream being generated using a stream cipher algorithm, wherein at least one of the generating a decorrelated media stream, the quantizing the decorrelated media stream, and the encoding the quantized decorrelated media stream is performed using a processor.

2. The method of claim 1, further comprising transmitting the cipher media stream.

3. The method of claim 1, further comprising:
receiving a media processing request from a media device; and
performing media operations on the cipher media stream based on the media processing request without decrypting the cipher media stream.

4. The method of claim 1, wherein the encoded media stream is combined with the keystream using a logical operator.

5. The method of claim 4, wherein the logical operator is an exclusive or (XOR) operator.

6. The method of claim 1, further comprising transmitting a key for generating the keystream through a secure transmission.

7. The method of claim 6, further comprising:
receiving the key at a media device;
receiving the cipher media stream at the media device, wherein the cipher media stream is compliant with media compression standards;
decrypting and decoding the cipher media stream, wherein the decoding comprises:
using an inverse stream cipher algorithm, generating a compressed media stream by combining the cipher media stream with a keystream generated using the key;
generating a decoded media stream by applying entropy decoding on the compressed media stream;
dequantizing the decoded media stream; and
generating an uncompressed media stream by applying an inverse decorrelation transform to the dequantized media stream.

8. The method of claim 1, wherein the cipher media stream is compliant with media compression standards.

9. A method of adaptive media streaming, the method comprising:
receiving a cipher media stream at a media device, wherein the cipher media stream is compliant with a media compression standard; and
decrypting and decoding the cipher media stream, wherein the decoding comprises:
using an inverse stream cipher algorithm to generate a compressed media stream by combining the cipher media stream with a keystream.

10. The method of claim 9, further comprising:
generating a decoded media stream by applying entropy decoding on the compressed media stream;
dequantizing the decoded media stream; and
generating an uncompressed media stream by applying an inverse decorrelation transform to the dequantized media stream.

11. The method of claim 10, further comprising displaying the uncompressed media stream.

12. The method of claim 9, further comprising:
performing media operations on the cipher media stream without decrypting the cipher media stream.

13. The method of claim 9, wherein the cipher media stream is combined with the keystream using a logical operator.

14. The method of claim 13, wherein the logical operator is an exclusive or (XOR) operator.

15. The method of claim 9, further comprising receiving a key for generating the keystream through a secure transmission.

16. A media server comprising:
a decorrelator configured to generate a decorrelated media stream by applying a decorrelation transform to media content to be streamed;
a quantizer configured to quantize the decorrelated media stream; and
an encoder comprising a entropy encoder, a stream cipher generator, and a keystream generator, wherein the entropy encoder is adapted to generate an encoded media stream by applying entropy encoding on the quantized decorrelated media stream, and wherein the stream cipher generator is adapted to use a stream cipher algorithm to generate a cipher media stream by combining the encoded media stream with a keystream from the keystream generator.

17. The media server of claim 16, further comprising a transmitter adapted to:
transmit the cipher media stream, and
transmit a key for generating the keystream through a secure transmission.

18. The media server of claim 16, further comprising:
a receiver adapted to receive a media processing request from a media device; and
a media processor to perform media operations on the cipher media stream based on the media processing request without decrypting the cipher media stream.

19. The media server of claim 16, wherein the stream cipher generator combines the encoded media stream with the keystream using a logical operator, wherein the logical operator is an exclusive or (XOR) operator.

20. The media server of claim 16, wherein the cipher media stream is compliant with media compression standards.

21. A media device comprising:
a receiver configured to receive a cipher media stream, wherein the cipher media stream is compliant with media compression standards; and
a decoder configured to decrypt and decode the cipher media stream, the decoder comprising a stream cipher generator and a keystream generator, wherein the stream cipher generator is configured to generate a compressed media stream by combining the cipher media stream with a keystream from the keystream generator using an inverse stream cipher algorithm.

22. The media device of claim 21, wherein the decoder further comprises a entropy decoder configured to generate a decoded media stream by applying entropy decoding on the compressed media stream, wherein the media device further comprises:
a dequantizer configured to dequantize the decoded media stream; and
an inverse decorrelator configured to generate an uncompressed media stream by applying an inverse decorrelation transform to the dequantized media stream.

23. The media device of claim 22, further comprising:
a receiver configured to receive a key for generating the keystream through a secure transmission; and
a display configured to display the uncompressed media stream.

24. The media device of claim 21, further comprising:
a media processor configured to perform media operations on the cipher media stream without decrypting the cipher media stream.

25. The media device of claim 21, wherein the stream cipher generator combines cipher media stream with the keystream using a logical operator, wherein the logical operator is an exclusive or (XOR) operator.
